(19) United States
(12) Patent Application Publication
(10) Pub. No.: US 2006/0261531 A1
(43) Pub. Date: Nov. 23, 2006

(54) Bush type hydraulic rubber mount and method of making same

(75) Inventor: Tae Sup Kim, Busan (KR)

Correspondence Address: NIXON PEABODY, LLP, 401 9TH STREET, NW, SUITE 900, WASHINGTON, DC, 20004-2128, US

(73) Assignee: DTR Co., Ltd., Jinju-si (KR)

(21) Appl. No.: 11/452,983

(22) Filed: Jun. 15, 2006

(30) Foreign Application Priority Data
May 17, 2005 (KR) 10-2006-0044157

(51) Int. Cl. F16F 13/00

(52) U.S. Cl. 267/140.12; 267/140.13

(57) ABSTRACT

Disclosed are a vehicle mount to be installed between the body and the frame of a vehicle or the engine and the frame, and a method of manufacturing the mount. The vehicle mount includes an inner sleeve and an outer sleeve surrounding the outer face of the inner sleeve with a space in-between. A first insulation rubber is installed between the inner sleeve and the outer sleeve and forming an internal space in-between. The first insulation rubber has an inner sleeve insertion hole into which the inner sleeve is inserted. The first insulation rubber is contracted or expanded to attenuate external vibration and change a shape of the internal space according to an applied load. A space divider is installed in radial direction inside the internal space to divide the internal space into an upper first internal space and a lower second internal space. The space divider is provided at least one side thereof with an orifice connecting the first and second internal spaces to each other. A fluid is filled in the internal pace. The fluid flows between the first and second internal spaces depending on a difference in pressures exerted on the first and second internal spaces to attenuate external vibration. The vehicle mount provides an axial hydraulic damping effect and its axial and radial rigidities can be adjusted.

### BACKGROUND OF THE INVENTION

1. Field of the Invention

The present invention relates to a mount and a method of manufacturing the same. In particular, the invention relates to a mount for vehicles and a method of manufacturing the same, which is installed between two structures, such as between a vehicle body and a frame or an engine and a frame, thereby buffering and absorbing impact and vibration transmitted between the two structures.

2. Background of the Related Art

In general, a frame is an important portion supporting the load transmitted from the body and the reaction force from the front and rear shafts. A mount is disposed between the frame and the body and between the frame and the engine and the like, in order that impact or vibration transferred to the frame from the road surface is prevented from being transmitted to the body and the like, and problems caused from the direction connection between the two structures can be avoided.

FIG. 1 is a sectional view showing a conventional bush type hydraulic rubber mount.

As depicted in FIG. 1, the conventional bush type hydraulic rubber mount 100 includes an inner sleeve 110 and an outer sleeve 120. Installed between the two sleeves 110 and 120 is an insulation rubber 130, which forms an internal space 140 in-between with the outer sleeve 120. A partition wall 142 is installed in the internal space 140 in the longitudinal direction of the sleeves 110 and 120 to thereby divide the internal space 140 into two parts. The divided internal spaces 140 are filled with fluid 144.

The insulation rubber 130 is provided with a connection hole 132 where the inner sleeve 110 is combined. Both ends of the insulation rubber 130 are extended outwardly to form a protrusion 134, which is closely contacted to the inner side face of the outer sleeve 120. An orifice ring 150 is mounted between the protrusion 134 and the inner face of the outer sleeve 120. The orifice ring 150 is provided with an orifice (not shown) for fluid-communicating two divided spaces, thereby providing a fluid-travelling path. Interposed between the orifice ring 150 and the inner face of the outer sleeve 120 is an O-ring 152 for sealing.

In addition, a stopper 160 is installed between the both protrusions 134 such that the insulation rubber 130 is prevented from being radially contracted beyond a certain limit.

In the conventional bush type hydraulic rubber mount 100 of FIG. 1, the hydraulic damping effect occurs only in the radial direction, not in the axial direction.

With the mount 100 of FIG. 1, it is difficult to obtain a high rigidity in axial direction. When it needs to be mounted in the vertical direction of a vehicle, it has a disadvantage of not being able to obtain an axial hydraulic damping effect.

Furthermore, with the bush type hydraulic rubber mount 100, it is not possible to control the axial and radial rigidities independently.

### SUMMARY OF THE INVENTION

Therefore, the present invention has been made in view of the above problems. It is an object of the invention to provide a bush type hydraulic rubber mount, which can obtain a hydraulic damping effect in axial direction and be mounted in the vertical direction of a vehicle.

Another object of the invention is to provide a bush type hydraulic rubber mount capable of independently control the axial rigidity and the radial rigidity.

A further object of the invention is to provide a method of manufacturing such bush type hydraulic rubber mounts.

To accomplish the above object, according to one aspect of the present invention, there is provided a bush type hydraulic rubber mount comprising: an inner sleeve; an outer sleeve surrounding the outer face of the inner sleeve while being spaced apart therefrom; a first insulation rubber having an inner sleeve insertion hole into which the inner sleeve is inserted, the first insulation rubber being installed between the inner sleeve and the outer sleeve and forming an internal space in-between, the first insulation rubber being contracted or expanded to attenuate external vibration and change a shape of the internal space according to an applied load; a space divider installed in radial direction inside the internal space to divide the internal space into an upper first internal space and a lower second internal space, the space divider being provided at least one side thereof with an orifice connecting the first and second internal spaces to each other; and a fluid filled in the internal pace, the fluid flowing between the first and second internal spaces depending on a difference in pressures exerted on the first and second internal spaces to attenuate external vibration.

In an embodiment, the first insulation rubber includes an upper body and an outer extension extended downwardly along the outside of the internal space from the upper body, and the space divider includes a first auxiliary sleeve combined along an outer circumferential face of the inner sleeve, a second insulation rubber installed along an outer circumferential face of the first auxiliary sleeve, and an orifice ring installed along an outer circumferential face of the second insulation rubber and having the orifice, the outer circumferential of the orifice ring being closely contacted with an inner wall face of the outer side of the internal space.

In an embodiment, the first insulation rubber is formed such that the internal space is opened downwards, the lower portion of the internal space is closed with a diaphragm mechanism, and the diaphragm mechanism includes a diaphragm made of rubber, a second auxiliary sleeve installed inwards of the diaphragm and combined along an outer circumferential face of the inner sleeve and a third auxiliary sleeve installed outwards of the diaphragm and combined along an inner side face of the outer sleeve.

In an embodiment, a latching step, to which the orifice ring is to be latched, is formed in an inner circumferential face of the outer extension.

In an embodiment, a fluid-flowing groove is formed along an outer circumferential face of the orifice ring, and the orifice includes a first orifice connecting the first internal space with one side of the fluid-flowing groove and a second orifice connecting the second internal space with the other side of the fluid-flowing groove.

In an embodiment, the fluid-flowing groove is closed at the both ends thereof. The first orifice is formed within 0˜15° from one end of the fluid-flowing groove and the second orifice is formed within 335˜350° from one end of the fluid-flowing groove.

In an embodiment, the first insulation rubber and the second insulation rubber are made of different rubber materials. In an embodiment, an upper plate is installed on top of the first insulation rubber in order to protect the first insulation rubber, the upper plate is integrally fixed to the inner sleeve, and the first insulation rubber has a protrusion formed in the outer side face thereof for receiving the support of the outer sleeve.

In an embodiment, the first insulation rubber is further provided with an inner extension extended along between the inner sleeve and the internal space, the first auxiliary sleeve is provided with a first expansion widely expanded upwards and inserted from the lower part of the internal space and fixed inside thereof, and the inner extension is interposed between the first expansion and the inner sleeve.

In an embodiment, the second auxiliary sleeve is provided with a second expansion widely expanded upwards and inserted from the lower part of the internal space and fixed inside thereof, and the lower portion of the first auxiliary sleeve and the lower portion of the second insulation rubber are interposed between the second expansion and the inner sleeve.

According to another aspect of the invention, there is provided a method of manufacturing a bush type hydraulic rubber mount. The method comprises the steps of: connecting a first insulation rubber between an inner sleeve and an outer sleeve, the outer sleeve surrounding the inner sleeve with a certain space from the inner space, the first insulation rubber being provided with an inner sleeve insertion hole into which the inner sleeve is inserted, the first insulation rubber forming an internal space between the inner sleeve and the outer sleeve and having an open bottom; inserting a space divider between the inner sleeve and the outer sleeve within a fluid through the open bottom of the first insulation rubber, the space divider being installed in radial direction inside the internal space to divide the internal space into an upper first internal space and a lower second internal space, the space divider being provided with an orifice formed at least on side thereof to connect the first internal space and the second internal space to each other; inserting a diaphragm mechanism between the inner sleeve and the outer sleeve within a fluid through the open bottom of the first insulation rubber, the diaphragm mechanism including a diaphragm made of rubber, a second auxiliary sleeve installed inwards of the diaphragm and combined along the outer circumferential face of the inner sleeve, and a third auxiliary sleeve installed outwards of the diaphragm and combined along the inner sidewall of the outer sleeve; and pressing the outer face of the outer sleeve inwardly to seal between the inner face of the outer sleeve and the third auxiliary sleeve.

### BRIEF DESCRIPTION OF THE DRAWINGS

The above and other objects, features and advantages of the present invention will be apparent from the following detailed description of the preferred embodiments of the invention, in conjunction with the accompanying drawings, in which:

FIG. 1 is a sectional view showing a conventional bush type hydraulic rubber mount;

FIG. 2 is a partially exploded perspective view of a bush type hydraulic rubber mount according to the invention;

FIG. 3 is a sectional view taken along the line I-I in FIG. 2;

FIG. 4 is a plan view of the orifice ring explaining the installation of a first orifice and a second orifice; and

FIG. 5 is a sectional view explaining a method of manufacturing a bush type hydraulic rubber mount according to the invention.

### DETAILED DESCRIPTION OF THE PREFERRED EMBODIMENT

Hereafter, the features of the invention will be explained in greater detail.

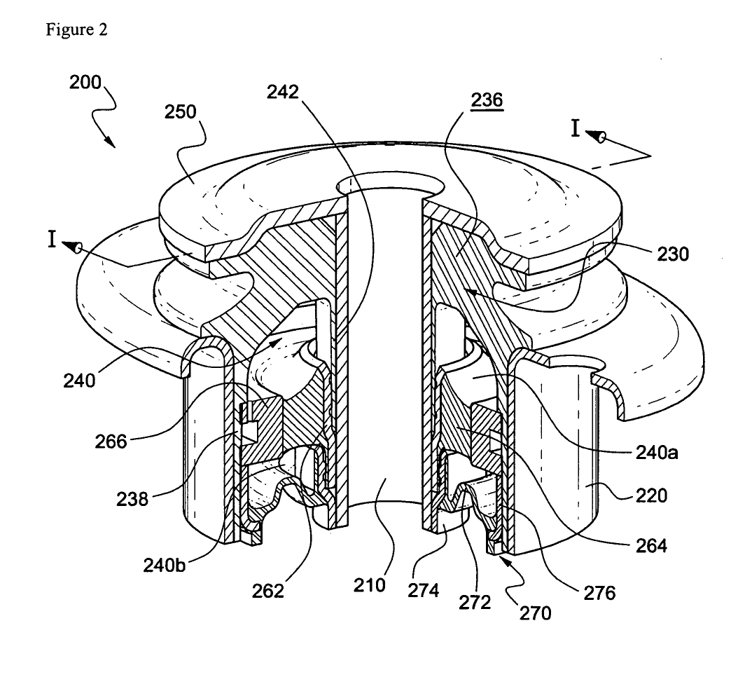

FIG. 2 is a partially exploded perspective view of a bush type hydraulic rubber mount according to the invention where the rubber mount of the invention is generally denoted by a reference numeral 200. FIG. 2 is a sectional view taken along the line I-I in FIG. 2.

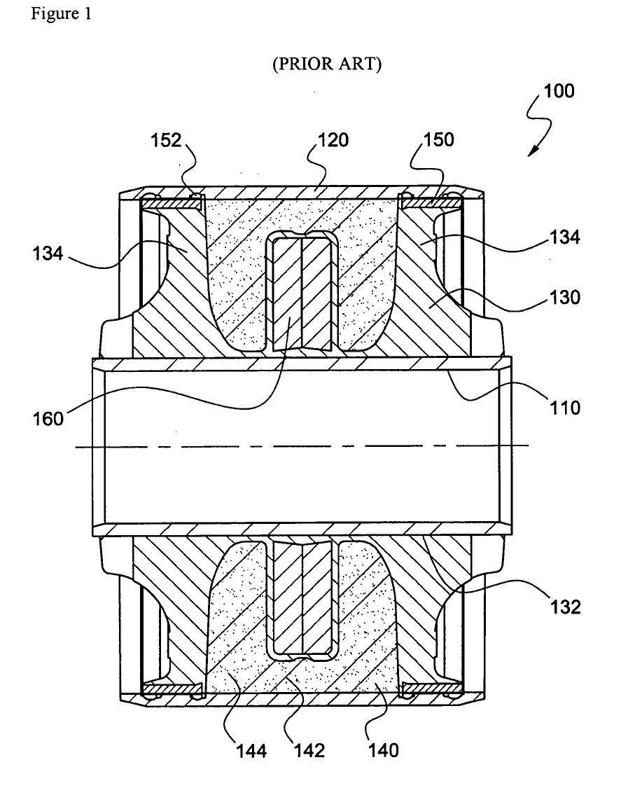

As illustrated in FIGS. 1 and 2, the bush type hydraulic rubber mount 200 of the invention includes an inner sleeve 210 and an outer sleeve 220 spaced apart from and surrounding the outer face of the inner sleeve 210. The inner sleeve 210 has a hollow cylindrical form. Similarly the outer sleeve 220 has a hollow cylindrical form and the upper end thereof is bent outwards so as to support a protrusion placed near the upper end of a first insulation rubber 230, which will be explained hereinafter.

The first insulation rubber 230 is mounted between the inner sleeve 210 and the outer sleeve 220. The first insulation rubber 230 is provided with an inner sleeve insertion hole 234 at the center of which the inner sleeve 210 can be inserted. An internal space 240 is formed between the inner sleeve 210 and the outer sleeve 220.

The first insulation rubber 230 includes an upper body portion 236 through which the inner sleeve insertion hole 234 passes, an outer extension 238 extended downwards along the outer side of the internal space 240 from the body portion 236, and an inner extension 242 extended downwards along between the internal space and the inner sleeve 210 from the body portion 236. The outer extension 238 is provided with a latching step 244 formed at the inner wall face. Between the inner extension 242 and the outer extension 238 is opened downward. The first insulation rubber 230 may be formed without the inner extension 242. As another alternative, without forming the outer extension 238, the outer sleeve 220 may be made to form an inner wall of the internal space 240, or a separate rubber may be attached to the inner face of the outer sleeve 220 to form the mount 200 of the invention. However, it is not preferable.

Formed in the outer circumferential face of the body portion 236 is a protrusion 232 for receiving support of the outer sleeve 220. A lateral extension 246 is formed above the protrusion 232 in a way to be extended outwardly from a position slightly lower than the top surface of the body portion 236 such that an upper plate 250 can be stably mounted on the top face of the body portion 236.

The above-configured first insulation rubber 230 functions to attenuate external vibration and change the shape of the internal space 240 while being contracted or expanded according to the applied load.

Installed on the top surface of the first insulation rubber 230 is an upper plate 250 for protecting the first insulation rubber 230. It is preferable that the upper plate 250 is fixed integrally with the inner sleeve 210.

The bush type hydraulic rubber mount 200 of the invention is provided with a space divider 260 disposed radially in the internal space to partition the internal space into an upper first internal space 240a and a lower second internal space 240b.

The space divider 260 is provided with a first auxiliary sleeve combined along the outer circumferential face of the inner sleeve 210. The first auxiliary sleeve 262 is provided with a first expansion 263 formed at the upper portion thereof. Interposed between the first expansion 283 and the inner sleeve 210 is the lower end of the inner extension 242, thereby providing an improved fluid-tightness in-between.

A second insulation rubber 264 is disposed along the outer circumferential face of the first auxiliary sleeve 262. The second insulation rubber 264 may be formed of a material different from the first insulation rubber 230. In this case, the axial and radial rigidities of the mount 200 can be independently adjusted.

An orifice ring 266 is installed along the outer circumferential face of the second insulation rubber 264. The outer circumferential face of the orifice ring 266 is closely contacted with the inner wall face outside of the internal space 240. Preferably, the inner wall face of the outer side of the internal space 240 is the outer extension 238 of the first insulation rubber 264, and in some cases may be other material coated in the inner wall face of the outer sleeve 220 or the inner wall face of the outer sleeve 220.

As illustrated in the figures, a fluid-flow groove 267 is formed along the outer peripheral face of the orifice ring 266. Formed in the orifice ring 266 are a first orifice 268 connecting one side of the fluid-flow groove 267 with the first internal space 240a and a second orifice connecting the other side of the fluid-flow groove 267 with the second internal space. Details thereon will be explained hereafter in greater detail.

As illustrated in the figures, a diaphragm 272 is installed at the lower portion of the internal space 240. Rubber is suitable for the diaphragm 272. The diaphragm 272 functions to control the size and shape of the second internal space 240b in such a way that it expands when the fluid 280 moves from the first internal space 240a to the second internal space 240b through the orifices 268 and 269 and it contracts when the opposite occurs.

The diaphragm 272 is configured to block the bottom of the second internal space 240b by means of a second auxiliary sleeve 274 installed inwards of the diaphragm and connected along the outer circumferential face of the inner sleeve 210 and a third auxiliary sleeve 276 installed outwards thereof and connected along the inner lateral face of the outer sleeve 220. The second auxiliary sleeve 274 and the third auxiliary sleeve 276 is for installation of the diaphragm 272 and thus may be called a diaphragm mechanism 270 together with the diaphragm 272.

As shown in the figures, the second auxiliary sleeve 274 is provided with a second expansion 275, the upper portion of which is expanded. The lower end of the second insulation rubber 264 and the lower end of the first auxiliary sleeve 262 can be interposed between the second expansion 275 and the inner sleeve 210.

In addition, the outer extension 238 of the first insulation rubber 230 is interposed between the outer face of the third auxiliary sleeve 276 and the inner face of the outer sleeve 220, thereby providing an improved fluid-tightness.

In some cases, of course, without providing the above diaphragm mechanism, the lower end of the outer extension 238 of the first insulation rubber 230 may be interposed between the outer face of the inner sleeve 210 and the first auxiliary sleeve 262, or attached to the inner sleeve 210 to thereby form the second internal space 240b. Similarly, the inner extension of the first insulation rubber is extended to be bonded with the outer extension or attached to the outer sleeve 220 to thereby form the second internal space 240b.

The internal space 240 is filled with a fluid 280, which attenuates external vibration while flowing between the first internal space 240a and the second internal space 240b through the orifices 268 and 269, depending on the difference in the pressures exerted on the first and second internal spaces 240a and 240b.

The fluid 280 employs an antifreeze solution of 70% mono ethylene glycol and 30% of mono propylene glycol, which is used as cooling water.

The above sleeves may be formed of iron material or the like. The orifice ring may be made of aluminum or aluminum alloys. The sleeve and the rubber, and the orifice ring and the rubber may be firmly bonded to each other using an adhesive or other known method.

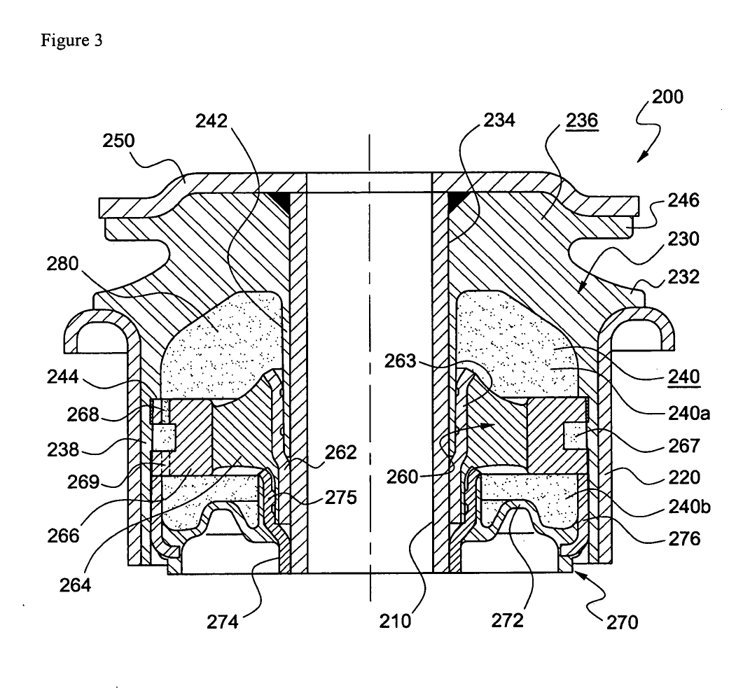

As explained above in FIGS. 2 and 3, the bush type hydraulic rubber mount 200 is installed between two structures, such as between a vehicle frame and a body or between a frame and an engine, through a bolt passing through the inner sleeve 210 and a nut coupled to the bolt. Thus, it attenuates impact and vibration transmitting between the two structures, while supporting the load of the upper structure.

That is, when the frame ascends due to roughness or the like of the road during travel, the first insulation rubber 230 is pressurized and contracted by means of the gravity of the body equipped on the upper plate 250 and thus buffers the impact transferred between the frame and the body and attenuates the vibration. As the first insulation rubber 230 is contracted, the first internal space 240a is reduced and the fluid 280 within the first internal space 240a is flown into the second internal space 240b through the orifices 268 and 269, thereby buffering the impact transferred between the frame and the body and attenuating the vibration. As the fluid 280 is introduced into the second internal space 240b, the diaphragm 272 is expanded. In the case where the frame descends after ascending, the first insulation rubber 230 expands and thus the first internal space 240a expands, i.e., the opposite operation to the above occurs to buffer the impact transferred between the frame and the body and attenuate the vibration.

During the above course of actions, the upper plate 250, the inner sleeve 210, the first insulation rubber 210 with the exception of the outer extension 238, the first auxiliary sleeve 262 and the second auxiliary sleeve 274 move up-and-down together. The outer sleeve 220, the orifice ring 266 and the third auxiliary sleeve 276 are fixed to the frame and thus do not move. In case of the second insulation rubber 264 and the diaphragm 272, its one end moves up-and-down between the moving portion and the non-moving portion to thereby allow for the movement of the moving portion.

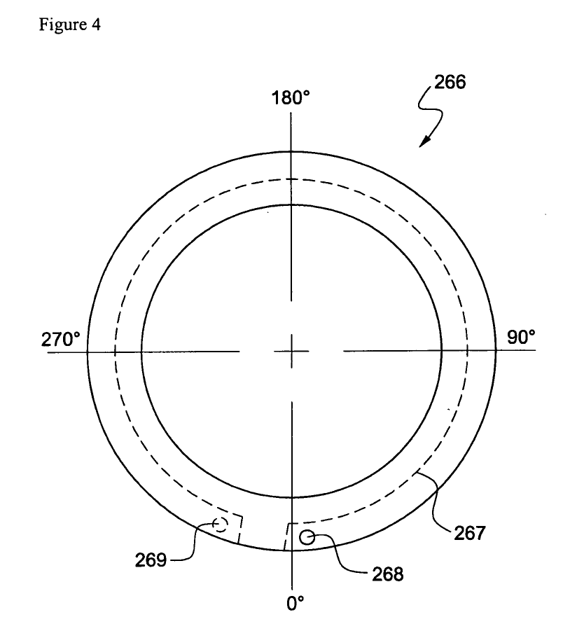

FIG. 4 is a plan view of the orifice ring explaining the installed state of the first orifice and the second orifice.

Referring to FIGS. 3 and 4, the orifice ring 266 is formed with a fluid-flowing groove 267 along its lateral face. It is preferable that the fluid-flowing groove is formed such that its both ends are not connected to each other, i.e., not along the entire circumference of the orifice ring 266, as shown in FIG. 4. At this state, the first orifice 268 is installed in such a way that the first internal space 240a and the fluid-flowing groove 267 are connected to each other near one end of the fluid-flowing groove 267. The second orifice 269 is installed such that the second internal space 240b and the fluid-flowing groove 267 are connected with each other near the other end of the fluid-flowing groove 267. In this way, a long buffering region is created between the first internal space 240a and the second internal space 240b so that a force transfer between the first and second internal spaces 240a and 240b can be performed in a delayed fashion to a certain degree.

In the above-described orifice ring 266, preferably the first orifice 268 is formed within 0˜15° from one end of the fluid-flowing groove 267 and the second orifice 269 is formed within 335˜350° from one end of the fluid-flowing groove 267.

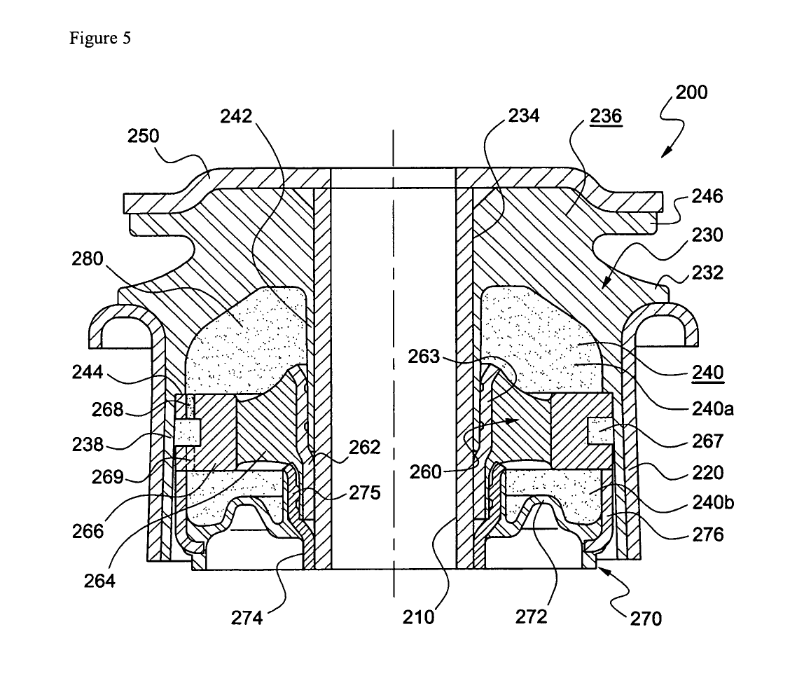

FIG. 5 explains a method of manufacturing a bush type hydraulic rubber mount according to the invention.

As illustrated in FIG. 5, first the inner sleeve 210 integrally formed with the upper plate 250 is inserted into the inner sleeve insertion hole 234 of the first insulation rubber 230. The outer sleeve 220 is inserted outside of the first insulation rubber 230.

Then, the above structure, in which the first insulation rubber 230 is combined between the inner and outer sleeves 210 and 220, is dipped in a container containing a fluid such as an anti-freeze fluid so that the fluid is filled in the internal space 240 of the first insulation rubber 230. At this state, the first auxiliary sleeve 262 of the space divider 260 is combined with the inner sleeve through the lower opening and then pushed upwards. At this time, part of the fluid 280 within the internal space 240 is discharged outside. In order for the space divider to be smoothly assembled and for the internal fluid to be smoothly flown out, preferably the outer extension of the first insulation rubber 230 and the outer sleeve is formed such that its inner diameter slightly increases gradually towards the lower side thereof, as shown in FIG. 5.

This may be achieved in such a way that the outer extension 238 of the second insulation rubber 230 is formed so as to decrease its thickness gradually towards the lower side thereof, or the diameter of the outer sleeve 220 is formed so as to be increased gradually towards the lower side thereof.

As the first auxiliary sleeve 262 of the space divider 260 is combined to the inner sleeve 210 and ascends, the second insulation rubber 264 and the orifice ring 266 ascend together. Consequentially, the inner extension 242 of the first insulation rubber 230 is completely inserted between the first extension 263 of the first auxiliary sleeve 262 and the inner sleeve 210 and the orifice ring 266 is latched with the latching step 244 to stop ascending.

Thereafter, the diaphragm 272 of the second auxiliary sleeve 274 and the third auxiliary sleeve 276 are combined between the inner sleeve 210 and the outer sleeve 220 though the lower opening of the internal space 240. As the second auxiliary sleeve 274 is combined with the inner sleeve 210 and ascends, the lower end of the second insulation rubber 264 and the first auxiliary sleeve 262 are inserted into and interposed between the second expansion 275 and the inner sleeve 210.

Then, while pressing the third auxiliary sleeve 276 upwardly, the outer face of the lower end of the outer sleeve 220 is pressed inwards such that the outer sleeve 220 and the outer extension 238 of the first insulation rubber 230 are closely contacted with the outer face of the third auxiliary sleeve 276. In this way, the bush type hydraulic rubber mount 200 of the invention is completed.

As described above, the bush type hydraulic rubber mount of the invention provides for a hydraulic damping effect in an axial direction.

In the bush type hydraulic rubber mount, the first insulation rubber and the second insulation rubber can be selected so as to have a desired rigidity and thus the axial and radial rigidities of the mount can be easily controlled and adjusted.

The method of the invention provides a bush type hydraulic rubber mount having a hydraulic damping effect in the axial direction and capable of controlling the axial and radial rigidities thereof as desired.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A bush type hydraulic rubber mount comprising:
an inner sleeve;
an outer sleeve surrounding the outer face of the inner sleeve while being spaced apart therefrom;
a first insulation rubber having an inner sleeve insertion hole into which the inner sleeve is inserted, the first insulation rubber being installed between the inner sleeve and the outer sleeve and forming an internal space in-between, the first insulation rubber being contracted or expanded to attenuate external vibration and change a shape of the internal space according to an applied load;
a space divider installed in radial direction inside the internal space to divide the internal space into an upper first internal space and a lower second internal space, the space divider being provided at least one side thereof with an orifice connecting the first and second internal spaces to each other; and
a fluid filled in the internal pace, the fluid flowing between the first and second internal spaces depending on a difference in pressures exerted on the first and second internal spaces to attenuate external vibration.

2. The hydraulic rubber mount as claimed in claim 1, wherein the first insulation rubber includes an upper body and an outer extension extended downwardly along the outside of the internal space from the upper body, and the space divider includes a first auxiliary sleeve combined along an outer circumferential face of the inner sleeve, a second insulation rubber installed along an outer circumferential face of the first auxiliary sleeve, and an orifice ring installed along an outer circumferential face of the second insulation rubber and having the orifice, the outer circumferential of the orifice ring being closely contacted with an inner wall face of the outer side of the internal space.

3. The hydraulic rubber mount as claimed in claim 1, wherein the first insulation rubber is formed such that the internal space is opened downwards, the lower portion of the internal space is closed with a diaphragm mechanism, and the diaphragm mechanism includes a diaphragm made of rubber, a second auxiliary sleeve installed inwards of the diaphragm and combined along an outer circumferential face of the inner sleeve and a third auxiliary sleeve installed outwards of the diaphragm and combined along an inner side face of the outer sleeve.

4. The hydraulic rubber mount as claimed in claim 2, wherein a latching step, to which the orifice ring is to be latched, is formed in an inner circumferential face of the outer extension.

5. The hydraulic rubber mount as claimed in claim 2, wherein a fluid-flowing groove is formed along an outer circumferential face of the orifice ring, and the orifice includes a first orifice connecting the first internal space with one side of the fluid-flowing groove and a second orifice connecting the second internal space with the other side of the fluid-flowing groove.

6. The hydraulic rubber mount as claimed in claim 2, wherein the first insulation rubber and the second insulation rubber are made of different rubber materials.

7. The hydraulic rubber mount as claimed in claim 1, wherein an upper plate is installed on top of the first insulation rubber in order to protect the first insulation rubber, the upper plate is integrally fixed to the inner sleeve, and the first insulation rubber has a protrusion formed in the outer side face thereof for receiving the support of the outer sleeve.

8. The hydraulic rubber mount as claimed in claim 2, wherein the first insulation rubber is further provided with an inner extension extended along between the inner sleeve and the internal space, the first auxiliary sleeve is provided with a first expansion widely expanded upwards and inserted from the lower part of the internal space and fixed inside thereof, and the inner extension is interposed between the first expansion and the inner sleeve.

9. The hydraulic rubber mount as claimed in claim 3, wherein the second auxiliary sleeve is provided with a second expansion widely expanded upwards and inserted from the lower part of the internal space and fixed inside thereof, and the lower portion of the first auxiliary sleeve and the lower portion of the second insulation rubber are interposed between the second expansion and the inner sleeve.

10. A method of manufacturing a bush type hydraulic rubber mount, the method comprising the steps of:
connecting a first insulation rubber between an inner sleeve and an outer sleeve, the outer sleeve surrounding the inner sleeve with a certain space from the inner space, the first insulation rubber being provided with an inner sleeve insertion hole into which the inner sleeve is inserted, the first insulation rubber forming an internal space between the inner sleeve and the outer sleeve and having an open bottom;
inserting a space divider between the inner sleeve and the outer sleeve within a fluid through the open bottom of the first insulation rubber, the space divider being installed in radial direction inside the internal space to divide the internal space into an upper first internal space and a lower second internal space, the space divider being provided with an orifice formed at least on side thereof to connect the first internal space and the second internal space to each other;
inserting a diaphragm mechanism between the inner sleeve and the outer sleeve within a fluid through the open bottom of the first insulation rubber, the diaphragm mechanism including a diaphragm made of rubber, a second auxiliary sleeve installed inwards of the diaphragm and combined along the outer circumferential face of the inner sleeve, and a third auxiliary sleeve installed outwards of the diaphragm and combined along the inner sidewall of the outer sleeve; and
pressing the outer face of the outer sleeve inwardly to seal between the inner face of the outer sleeve and the third auxiliary sleeve.
